(19) United States
(12) Patent Application Publication
(10) Pub. No.: US 2015/0333520 A1
(43) Pub. Date: Nov. 19, 2015

(54) DISTRIBUTION BOARD FOR INDEPENDENT MICROGRID

(71) Applicant: KC Cottrell Co., Ltd., Seoul (KR)

(72) Inventors: JONGBO AHN, Gyeongsangnamdo (KR); SUNGJOO LEE, Seoul (KR); Ki Nam Kwon, Gyeonggi-do (KR)

(21) Appl. No.: 14/714,308

(22) Filed: May 17, 2015

(30) Foreign Application Priority Data
May 16, 2014 (KR) 10-2014-0058872

(51) Int. Cl. H02J 3/38

(52) U.S. Cl. CPC H02J 3/382; H02J 3/383; H02J 3/386

(57) ABSTRACT

Disclosed is a distribution board for independent microgrid capable of driving a power loads at a remote place such as an island area or a mountainous area etc. with a power generated by using a renewable energy generating device and a diesel generating device using a fossil fuel, preventing a power failure etc. by selectively or successively blocking other loads or unimportant loads among the power loads at need, and stably recovering power supply by preventing an excessive inrush current by successive power supply in a re-driving process.

### BACKGROUND OF THE INVENTION

1. Field of the Invention

The present invention relates to a distribution board for independent microgrid, and more particularly, to a distribution board for independent microgrid capable of driving a power loads at a remote place such as an island area or a mountainous area etc. with a power generated by using a renewable energy generating device and a diesel generating device using a fossil fuel, preventing a power failure etc. by selectively or successively blocking other loads or unimportant loads among the power loads at need, and stably recovering power supply by preventing an excessive inrush current by successive power supply in a re-driving process.

2. Description of the Related Art

Presently, in case of the diesel electric power system, which is a main power source of the island area, there is a problem of causing the environment problem. Moreover, since the cost of the diesel fuel delivery from the land is included in the production cost, there is a problem in that the generation cost of the electric power is increased. Therefore, even though the initial installation fee is high, in a remote place such as an island area or a mountainous area etc., it is necessary to supply the power by using a renewable energy such as a solar power, a wind force, and a tidal power etc. in that the maintenance thereof is costless.

A microgrid is a kind of the distribution manner of the power like a smart grid. Here, the smart grid serves to organically control the total power net through an information gathering. On the other hand, the microgrid means any manner of controlling the demand power and the supply power in the power supply source of a small scale as necessary.

During the electric power supply on the remote place such as an island area or a mountainous area and so on, which is located away from the land, without the existing commercial power net, it appropriately needs to control the electric power supply through the microgrid mode by using a renewable energy generation and a diesel generation. At this time, in case of the power through the renewable energy generation, it is difficult to predict and control the power amount thereof. Also, since the inconsistency between of the power amount and the demand thereof is frequent generated, it is necessary to maintain and control the voltage and the frequency of the independent electric power system. That is, in the system for independently supplying the power by using the power source of the limited capacity, it appropriately controls the electric power supply so as to prevent the unbalance between the demand and the supply of the power owing to the sudden rising of the demand power, the abrupt malfunction of the specification machinery, and the abrupt output change of the renewable energy generation etc., so that the power failure can be prevented and the stable operation can be made.

In order to solve the above problem, the output thereof can be rapidly increased or decreased through the battery storage device etc. in response to the unbalance of the supply and the demand. However, if it fails to do so, the other action such as the blocking of the load etc. should be considered.

Korean patent registration No. 10-1373487 (registration date: Mar. 5, 2014) discloses a independent generating system having a fuel cell for supplying independently the power in the demanding place in response to the variable power loads. However, in the technology, a distribution board serves to essentially supply the power generated from the fuel cell power generating device to the demanding place and selectively supply the power generated from the secondary power generating device to the demanding place. That is, it is unable to control the electric power supply so as to prevent the unbalance between the demand and the supply of the power owing to the sudden rising of the demand power or the abrupt output change of the renewable energy generation etc. Also, there is a limit in that it cannot optimize the driving of the electric power system through the prediction of the output power and the power loads.

### SUMMARY

Accordingly, the present invention has been made to solve the above-mentioned problems occurring in the prior art, and a object of the present invention is to provide a distribution board for independent microgrid capable of driving a power loads at a remote place such as an island area or a mountainous area etc. with a power supplied from a diesel generating device, a renewable energy generating or a battery storage device operated independently with a commercial power supply plant, preventing a power failure etc. by selectively or successively blocking other loads or unimportant loads among the power loads at need, and stably recovering power supply by preventing an excessive inrush current by successive power supply in a re-driving process.

According to an aspect of the invention to achieve the object described above, there is provided a distribution board for independent microgrid, the independent microgrid comprising a plurality of modulated power supply devices having a diesel generating device for producing a power by using a fossil fuel, a renewable energy generating device for producing a power by using a renewable energy including a solar power, a wind force, and a tidal power, and a battery storage device for storing the power produced by the diesel generating device or the renewable energy generating device as necessary; and a power loads as a load feeder for consuming the power supplied from the power supply device in a state of independently installing at a remote place including an island area or a mountainous area, wherein the power loads is classified into important loads, unimportant loads, and other loads; the power loads and the power supply device are connected to each other in a state that a separate opening and closing switch or a separate static transfer switch is provided every unimportant loads and other loads; and a blocking of other loads or unimportant loads is successively made according to the importance of the load in a case of generating an unbalance between the power supplied from the power supply device and the power consumed by the power loads or a stable recover of the power supply is made by successively inputting blocked other loads or blocked unimportant loads in a resupplying of the power.

Also, the distribution board has a current transformer used in common with a power management system and a digital wattmeter so as to make a calculation through the power management system and a display of a current value through the digital wattmeter at the same time. Moreover, the changes of the output power supplied from the power supply device and the power loads is calculated in real time through a digital signal processor provided in a power management system and the successive blocking or inputting on the unimportant loads or other loads is made according to the result of the calculation so as to improve the power stability of the corresponding area.

In the meantime, the distribution board transmits the transaction data of the generating power and the power loads through the power supply device to an energy management system in a state that it is linked with the energy management system through a communication port and the energy management system conducts an energy management including a prediction of the power loads and a plan of the power generation through the received data.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a configuration including a distribution board for independent microgrid according to the present invention;

FIG. 2 is a detail diagram including a circuit of a distribution board for independent microgrid according to the invention;

FIG. 3 is a circuit diagram showing a configuration of a power management system for controlling a power measurement and opening and closing switches and an interface thereof according to the present invention;

FIG. 4 is a graph showing changes of predictive values and experimental values of output powers through an energy management system according to the present invention; and

FIG. 5 is a drawing showing the distribution board used in the present invention.

### DETAILED DESCRIPTION OF THE PREFERRED EMBODIMENT

Hereinafter, a preferred embodiment of the invention will be described in detail with reference to the accompanying drawings.

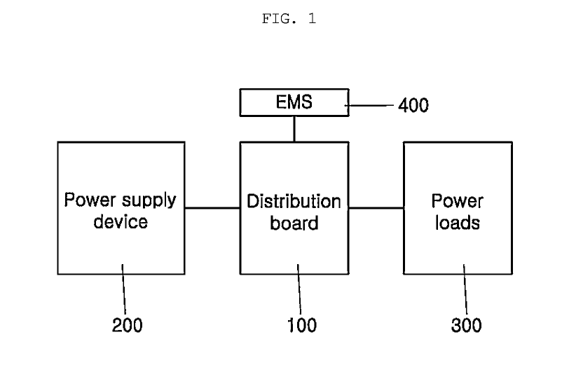

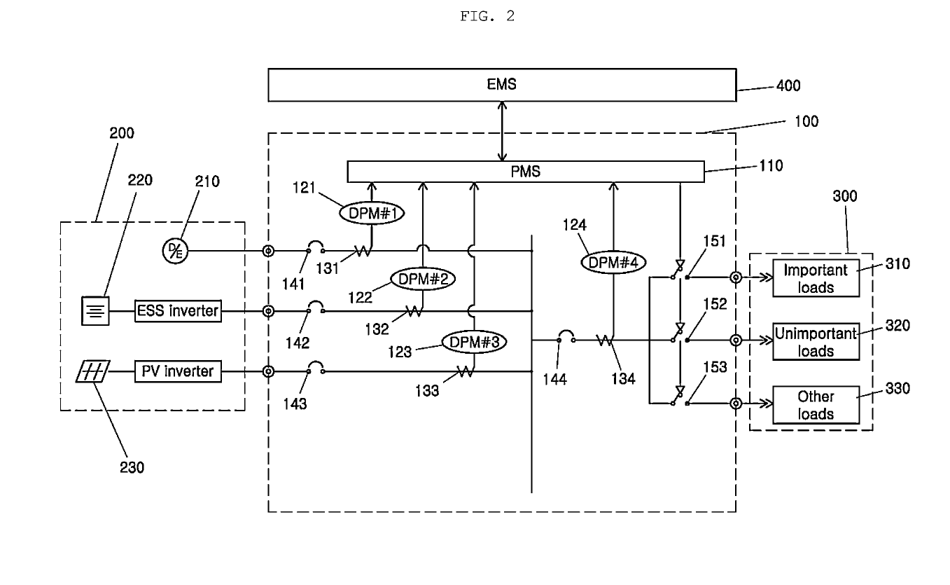

FIG. 1 is a block diagram showing a configuration including a distribution board for independent microgrid according to the present invention and FIG. 2 is a detail diagram including a circuit of a distribution board for independent microgrid according to the invention. The present invention relates to a distribution board applied to the independent microgrid including a power supply device 200 having a diesel generating device 210, a battery storage device 220, and a renewable energy generating device 230 capable of producing power by using a renewable energy including a solar power, a wind force, and a tidal power at a remote place such as an island area or a mountainous area etc. The power supply device is modulated by the diesel generating device, the battery storage device and the renewable energy generating device and the plurality of the modulated power supply devices is connected to the distribution board to be controlled.

The diesel generating device serves to produce the power by using a fossil fuel such as an oil and so on and the battery storage device serves to store the power produced by the diesel generating device or the renewable energy generating device and supply the power to a power loads according to the control of the distribution board. For example, the power of the battery storage device is transformed to the alternating current through the ESS inverter to be supplied. The power supplied from the renewable energy generating device is transformed to the alternating current through the PV inverter to be supplied.

In the independent microgrid, the distribution board 100 for connecting the power supply device 200 and the power loads 300 to each other is utilized. The distribution board 100 includes circuit breakers 141˜144 for protecting the diesel generating device 210, the battery storage device 220, and the renewable energy generating device of composing individually the power supply device 200 and important loads 310, unimportant loads 320, and other loads 330 of composing individually the power loads; and digital wattmeter 121˜124 for detecting the situation of the voltage, the current, and the power generated by the diesel generating device 210, the battery storage device 220, and the renewable energy generating device 230 of composing individually the power supply device 200 to be displayed and detecting the situation of the voltage, the current, and the power generated supplied to the power loads 300 to be displayed.

The digital wattmeter 121˜124 serves to detect the states of the voltage, the current, and the power of the individual components of the power supply device and the power loads 300 to be displayed. That is, the output voltage of the power supply device 200 and the voltage consumption of the power loads 300 are directly connected to each digital wattmeter and the output current and the current consumption are connected to each digital wattmeter via each current transformer 131˜134.

A power management system (PMS) 110 equipped in the distribution board 100 serves to monitor the output power (including voltage and current) of the diesel generating device 210, the battery storage device 220, and the renewable energy generating device 230, which are individual components of the power supply device 200, and the power consumption (including voltage and current) of the important loads 310, the unimportant loads 320, and other loads 330, which are individual components of the power loads. The power management system (PMS) 110 serves to urgently drive the diesel generating device 210 in case of emergency in response to the situation of the renewable energy generating device 230 of the power supply device 200 in which the output thereof is changed according to the natural condition or prevent a power failure etc. at a corresponding remote place in response to the abrupt change of the output power supplied from the power supply device or the abrupt change of the power consumption consumed from the power loads.

For this, the power management system 110 serves to detect the current supplied from the diesel generating device 210, the battery storage device 220, and the renewable energy generating device 230 of the power supply device 200 and the power loads 300. At this time, in the present invention, instead of detecting the current using the separate current transformer, the current transformers 131˜134, which are connected to the digital wattmeter, are used in common, so that the configuration within the distribution board 100 can be simplified and the manufacturing cost thereof can be reduced. Also, the current transformers are used in common, so that the calculation through the power management system and the display of the current value through the digital wattmeter can be simultaneously made.

The power loads 300, which is a load feeder provided in the distribution board 100 for independent microgrid according to the present invention, can be classified into the important loads 310, the unimportant loads 320, and other loads 330. Also, it is possible to more subdivide them according to the situations of the corresponding area. For example, the important loads 310 can include an emergency lighting or a commercial facility etc., the unimportant loads 320 can include the load capable of stopping the driving in case of emergency such as a desalination facility or a garbage incineration plant etc., and other loads 330 can include the load for the general home. The opening and closing switches 151˜153 are separately formed at the important loads 310, the unimportant loads 320, and other loads 330, so that the power interruption and the power supply can be successively made.

In the independent microgrid of the present invention, the diesel generating device 210 and the battery storage device 220 of the power supply device 200 are any power source capable of controlling as necessary. On the contrary, the renewable energy generating device has the characteristic in that the output is varied according to the natural conditions such as an amount of the solar radiation, an illumination, air volume, and an amount of waves and so on. The energy management system (EMS) 400 of the present invention predicts the load 300 of the corresponding area, devises a power generation plan in a state of predicting the output power of the corresponding area produced from the renewable energy generating device 230, and transmits the signals for driving the power supply device 200 according to the power generation plan, for example, by classifying it by season or monthly etc., to the distribution board 100 so as to steadily control the power supply and consumption of the corresponding area.

However, in case of deviating the power generation plan by the energy management system 400, that is, in case of the abrupt variation of the power loads, the abrupt trip due to the malfunction of the individual components of the power supply device 220 or the abrupt change of the output by means of the renewable energy generating device 230, it is deviated from the predicted power generation and consumption, thereby causing the unbalance thereof. Where the currently driven power supply device is unfit for the unbalance, the rising or the falling of the voltage and the frequency can occur. Due to this, since the problems such as the power failure and so on can arise overall in the corresponding area, it can be in the danger.

When it has the sudden change of the power generation or the consumption of deviating from the predicted range, the successive block of the power loads according to the importance of the load can be made by means of the power management system 110 equipped in the distribution board 100. That is, when it has the change of deviating from the predetermined load range within the predetermined time, for example, where the power consumption of the actual electric power loads is increased within 1 hour in a state of deviating from 10% of the forecast power consumption according to the power generation plan, the power management system 110 judges that the surplus power are insufficient and control the opening and closing switches 152 and 153 so as to block the load in the order of other loads 230 and the unimportant loads 220. In this case, the power management system 110 serves to drive the battery storage device 220 among the power supply device 200 together with the block of the load so as to output the stored surplus power or control the diesel generating device 210 to be driven.

Thereafter, where it judges that the load was stabilized or the surplus power is enough, for example, where the surplus power is increased in the range of 10˜20% in comparison with the power generation plan, the power management system 110 allows the blocked unimportant loads 320 and other loads 330 to be successively connected so as to normally drive them.

It is needed for the following purpose to classify the power loads 300, which are the load feeder, according to the importance thereof and block or input each load. That is, after the entire corresponding area has the power failure owing to an accident etc, where the normal operation is possible through the recovery etc., the individual components of the power supply device 200 are driven under the control of the energy management system 400. According to the completion of the driving, the voltage and the frequency of the corresponding area are stabilized within the determined range. At this time, where all loads 310, 320, and 330 of the power loads 300 are simultaneously inputted, the system is unstable while the excessive rush current is flowed therein or the power failure can be again generated. To prevent this problem, in the present invention, the power loads 300 can be successively driven in the order of the importance load 310, other load 330, and the unimportant load 320 and so on and the successive driving of the power loads 300 can be performed through the power management system 110 provided in the distribution board 100 of the present invention.

The opening and closing switches 151˜153 for blocking or inputting the power loads 300 may be an electromagnetic contactor, which is mechanically operated. Also, The opening and closing switches 151˜153 may be a static transfer switch without the momentary power failure etc. for high speed block. In case of the static transfer switch, since the block can be accomplished within the half cycle of the power frequency of 60 Hz, it has the advantage in that the block or the input of the power loads 300 can be steadily accomplished. In the present invention, since the switching speed has the range of 5˜200 ms, the block or the input of the stable load is accomplished through the fast switching.

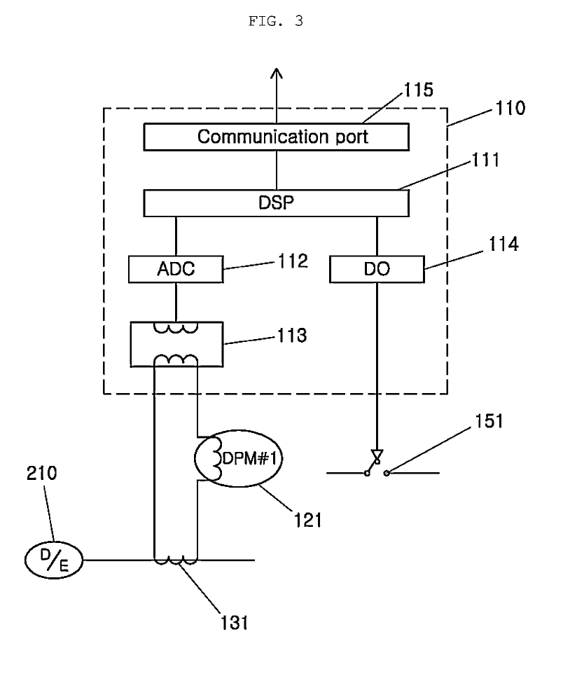

FIG. 3 is a circuit diagram showing a configuration of a power management system 110 for controlling a power measurement and opening and closing switches and an interface thereof according to the present invention. The power management system 110 is a digital controller including a digital signal processor (DSP) 111, an analog-digital converter (ADC) 112, a digital output device (DO) 114, and a communication port 115. By means of the above configuration, the power management system 110 of the present invention serves to measure the voltage and the current of the diesel generating device 210, the battery storage device 220 and the renewable energy generating device 230, which are the individual components of the power supply device 200, and the voltage and the current of the power loads 300 and perform the function of rapidly calculating them by the effective value. There is an advantage of rapidly detecting the unbalanced situation of the power generation and the demand without the time delay through the fast calculation function by means of the power management system 110.

A program capable of rapidly conducting the effective value calculation and determining whether the block or the input of the power loads is needed is installed in the digital signal processor 111. In a state that the program is driven, the digital signal processor 111 can rapidly detect the size of the voltage and current of the power supply device and the power loads and the changed circumstances thereof by the effective value and determine the input state or the block state of the power supply device and the power loads by using the effective value.

The power management system 110 of the present invention exchanges the information with the energy management system 400, which is located in the high level. Accordingly, the information associated with the successive input of the load is transmitted to the energy management system 400 to be stored, during the return operation etc. after the power failure. According to this, the information can be used for the establishment of the power generation plan.

The power management system 110 of the present invention includes an insulated separate current sensor 113 therein. The current sensor 113 serves to stably detect the output current of the diesel generating device 210, the battery storage device 220, and the renewable energy generating device 230, which are the individual components of the power supply device 200. For example, as shown in FIG. 3, the current sensor 113 detects the output of the current transformer 131 via the digital wattmeter 121 so as to detect the output current of the diesel generating device 210. As described above, the current transformers 131 are used in common, so that the calculation through the power management system 110 and the display of the current value through the digital wattmeter can be made at the same time.

In a state that the electric energy supplied in real time is established in advance by using the prediction amount of the power loads 300 and the prediction amount of the output power generated from the diesel generating device 210 and/or the renewable energy generating device 230, the energy management system 400 of the present invention allows the corresponding information to be transmitted to the distribution board 100 so as to produce the predicted power every predetermined time. Where it has the sudden change of the load and/or the power, the power management system 110 of the distribution board 100 serves to detect the corresponding change signal and autonomously control the blocking of the other loads 330 and the unimportant loads 320 or the devices so as to prevent the corresponding area from being a power failure overall.

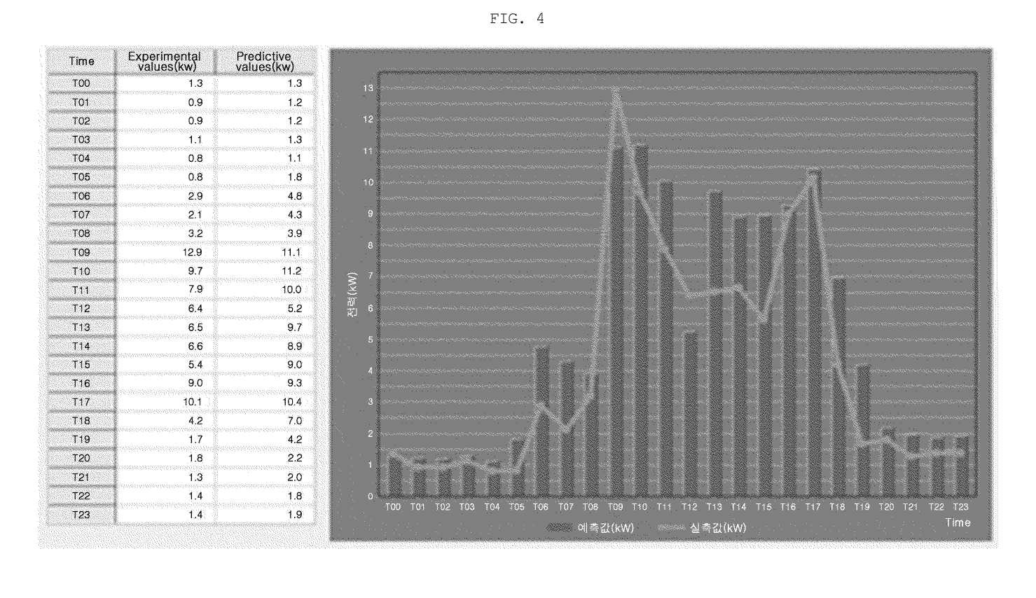

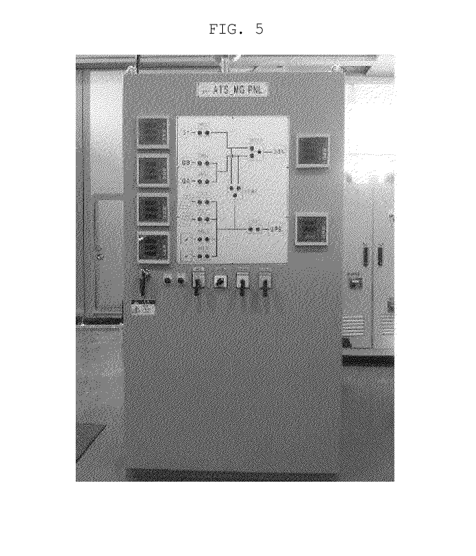

FIG. 4 is a graph showing changes of predictive values and experimental values of output powers through an energy management system 400 according to the embodiment of the present invention and FIG. 5 is a drawing showing the distribution board used in the present invention. Referring to FIG. 4, it shows that the output power can be produced in real time according to the predictive value of the output power through the historical data by means of the energy management system 400. Like FIG. 4, the changes of predictive values and experimental values of the output power through the historical data by means of the energy management system 400 can be illustrated in a graph.

According to the present invention, there are effects in that it prevents the power failure etc. by selectively or successively blocking other loads or unimportant loads among the power loads in response to the abrupt decreasing of the output power or the abrupt increasing of the power consumption consumed from power loads by means of the renewable energy generating device at a remote place such as an island etc., in that the power supply is independently operated, and stably recovers the power supply by preventing an excessive inrush current by successive power supply in a re-driving process.

According to the present invention, there is another effect in that it can stably maintain the system of the corresponding area through the opening and closing switch having relatively fast transfer time, in case of successively blocking or re-driving other loads or unimportant loads among the power loads.

According to the present invention, the distribution board is acted as the master on the plurality of modulated power supply devices, so that it can detect the malfunction of the system, thereby quickly coping with the reaction of the transient time.

Although the invention has been described according to the preferred embodiment mentioned above, the invention can be variously changed and modified without deviating from the essential point and scope of the invention. Accordingly, the accompanying Claims include such change and modification belonging to the essential point of the invention.

What is claimed is:

1. A distribution board for independent microgrid, the independent microgrid comprising a plurality of modulated power supply devices having a diesel generating device for producing a power by using a fossil fuel, a renewable energy generating device for producing a power by using a renewable energy including a solar power, a wind force, and a tidal power, and a battery storage device for storing the power produced by the diesel generating device or the renewable energy generating device as necessary; and a power loads as a load feeder for consuming the power supplied from the power supply device in a state of independently installing at a remote place including an island area or a mountainous area,
wherein the power loads is classified into important loads, unimportant loads, and other loads; the power loads and the power supply device are connected to each other in a state that a separate opening and closing switch or a separate static transfer switch is provided every unimportant loads and other loads; and a blocking of other loads or unimportant loads is successively made according to the importance of the load in a case of generating an unbalance between the power supplied from the power supply device and the power consumed by the power loads or a stable recover of the power supply is made by successively inputting blocked other loads or blocked unimportant loads in a resupplying of the power.

2. The distribution board for independent microgrid according to claim 1, wherein the distribution board has a current transformer used in common with a power management system and a digital wattmeter so as to make a calculation through the power management system and a display of a current value through the digital wattmeter at the same time.

3. The distribution board for independent microgrid according to claim 1, wherein the changes of the output power supplied from the power supply device and the power loads is calculated in real time through a digital signal processor provided in a power management system and the successive blocking or inputting on the unimportant loads or other loads is made according to the result of the calculation so as to improve the power stability of the corresponding area.

4. The distribution board for independent microgrid according to claim 1, wherein the distribution board transmits the transaction data of the generating power and the power loads through the power supply device to an energy management system in a state that it is linked with the energy management system through a communication port and the energy management system conducts an energy management including a prediction of the power loads and a plan of the power generation through the received data.
